(19) United States
(12) Patent Application Publication
(10) Pub. No.: US 2026/0328911 A1
(43) Pub. Date: Oct. 22, 2026

(54) DISTANCE MEASURING DEVICE, DISTANCE MEASURING METHOD, AND RECORDING MEDIUM

(71) Applicant: Masahiro Morimoto, Mishima Shizuoka (JP)

(72) Inventor: Masahiro Morimoto, Mishima Shizuoka (JP)

(73) Assignee: ETRIA Co., Ltd., Kanagawa (JP)

(21) Appl. No.: 19/450,029

(22) Filed: Jan. 15, 2026

(30) Foreign Application Priority Data
Apr. 18, 2025 (JP) 2025-068702

(51) Int. Cl. G01S 7/481; G01S 17/08

(52) U.S. Cl. CPC G01S 7/4814; G01S 17/08

(57) ABSTRACT

A distance measuring device includes: an output unit that outputs laser light with a variable wavelength; a light receiving unit that receives laser light; and a control unit that causes the output unit to output identification information of the distance measuring device by laser light, and determines a wavelength of laser light to be output from the output unit based on a light reception state of identification information for each distance measuring device by the light receiving unit.

### CROSS-REFERENCE TO RELATED APPLICATION

This application is based upon and claims the benefit of priority from Japanese Patent Application No. 2025-068702, filed Apr. 18, 2025, the entire content of which is incorporated herein by reference.

### FIELD

The present disclosure relates to a distance measuring device, a distance measuring method, and a recording medium.

### BACKGROUND

A distance measuring device that performs distance measurement through scanning with laser light is known and is also referred to as LiDAR (Light Detection and Ranging).

When multiple distance measuring devices perform distance measurement simultaneously with overlapping fields of view, interference between the laser lights from the multiple distance measuring devices may cause erroneous distance measurements or measurement errors.

### BRIEF DESCRIPTION OF THE DRAWINGS

FIG. 1 is a diagram showing a configuration example of a distance measuring device according to an embodiment.

FIG. 2 is a diagram showing an example of the appearance of the distance measuring device according to the embodiment.

FIG. 3 is a diagram showing a first example of laser light output by the distance measuring device according to the embodiment.

FIG. 4 is a diagram showing a second example of laser light output by the distance measuring device according to the embodiment.

FIG. 5 is a diagram showing a third example of laser light output by the distance measuring device according to the embodiment.

FIG. 6 is a diagram showing an example of a processing procedure performed by the distance measuring device according to the embodiments.

FIG. 7 is a diagram showing an example of a procedure in which the distance measuring device according to the embodiment performs a wavelength change process.

FIG. 8 is a diagram showing an example of a procedure in which the distance measuring device according to the embodiment assigns laser light wavelengths to its own device and to all other devices that can exchange information with its own device.

FIG. 9 is a diagram showing an example of a procedure performed by another device that receives wavelength assignment from a wavelength determination distance measuring device according to the embodiment.

FIG. 10 is a diagram showing a configuration example of a computer according to the embodiment.

### DETAILED DESCRIPTION

A distance measuring device of an embodiment includes an output unit, a light receiving unit, and a control unit. The output unit outputs laser light with a variable wavelength. The light receiving unit receives laser light. The control unit causes the output unit to output identification information of the distance measuring device by laser light, and determines a wavelength of laser light to be output from the output unit based on a light reception state of identification information for each distance measuring device by the light receiving unit.

A distance measuring device, a distance measuring method, and a recording medium according to an embodiment are capable of preventing erroneous distance measurements or measurement errors caused by interference between laser lights from multiple distance measuring devices in the case where the distance measuring devices perform distance measurement simultaneously with overlapping fields of view.

As used throughout this disclosure, the singular forms “a,” “an,” and “the” include plural reference unless the context clearly dictates otherwise.

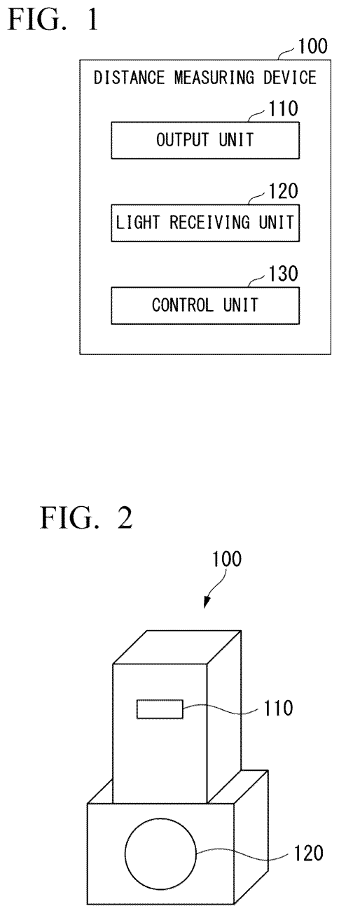

FIG. 1 shows a configuration example of a distance measuring device 100 according to an embodiment. In the configuration shown in FIG. 1, the distance measuring device 100 includes an output unit 110, a light receiving unit 120, and a control unit 130. The distance measuring device 100 is configured as a LiDAR device, and performs distance measurements by means of scanning with laser light. In particular, the distance measuring device 100 is configured to have a variable laser light wavelength. In the case where multiple distance measuring devices 100 simultaneously perform distance measurements with overlapping fields of view, mutually different wavelengths can be used. This makes it possible to prevent erroneous distance measurements or measurement errors caused by the interference of laser lights from these distance measuring devices 100.

The output unit 110 outputs laser light with a variable wavelength. The output unit 110 performs scanning using laser light. Moreover, the output unit 110 outputs information related to its own distance measuring device 100 using laser light. Here, “its own device” refers to a device that includes the relevant component. For the output unit 110, its own distance measuring device 100 is the distance measuring device 100 that includes that output unit. The information about its own device output by the output unit 110 by means of the laser light is also referred to as an optical communication code. The output of the laser light may also be referred to as irradiation of the laser light. The output of the optical communication code may also be referred to as transmission of the optical communication code. The light reception of the optical communication code may also be referred to as reception of the optical communication code. The output unit 110 may include a wavelength-variable infrared laser diode or a wavelength-variable near-infrared laser diode, and a scanning mechanism.

The method of scanning performed by the output unit 110 is not limited to a particular method. For example, the output unit 110 may perform scanning using a galvano scanner method. Alternatively, the output unit 110 may perform the operation using a polygon mirror method. Alternatively, the output unit 110 may perform scanning using a solid state method such as a micro electro mechanical systems (MEMS) method. The output unit 110, under the control of the control unit 130, outputs the laser light, performs scanning using the laser light, and outputs information using the laser light.

The light receiving unit 120 receives the laser light. The light receiving unit 120 can receive laser light having wavelengths that are within the range of wavelengths that can be output by the output unit 110, or over a wider wavelength range. The light receiving unit 120 receives and detects reflected light of the laser light output by the output unit 110. Moreover, in the case where multiple distance measuring devices 100 are provided, the light receiving unit 120 also receives and detects laser light output from other distance measuring devices 100 within the field of vision (FOV) of the light receiving unit 120 itself. The laser light output by the other distance measuring device 100 and received by the light receiving unit 120 may be direct light or reflected light.

The control unit 130 controls each unit of the distance measuring device 100 and executes various processes. For example, the distance measuring device 100 may include a computer such as a microcontroller, and the control unit 130 may be implemented in that computer. Functions of the control unit 130 may be executed by a CPU (Central Processing Unit) included in the computer reading out a program from a storage device and executing the program.

The control unit 130 determines the wavelength of the laser light to be output by the output unit 110. The control unit 130 controls the output unit 110 to output laser light of the determined wavelength and to perform scanning using the laser light. The control unit 130 also controls the output unit 110 to output an optical communication code. In particular, the control unit 130 causes the output unit 110 to output an optical communication code that includes identification information of its own distance measuring device 100. Furthermore, the control unit 130 may cause the output unit 110 to output an optical communication code including one or more of: information indicating the wavelength of the laser light output by the output unit 110; information indicating the wavelength of the laser light that can be output by the output unit 110; and information indicating the priority of its own distance measuring device 100.

Alternatively, the control unit 130 may preliminarily store information indicating the wavelength of the laser light that each distance measuring device 100 can output, and information indicating the priority of the distance measuring device 100, in association with the identification information of the distance measuring device 100. Moreover, the control unit 130 may detect the wavelength of the laser light output by each distance measuring device by analyzing the laser light received by the light receiving unit 120.

Also, the control unit 130 calculates the distance from its own distance measuring device 100 to each part of a measurement target object based on the light reception state by the light receiving unit 120. As a method for calculating the distance to each part of the measurement target object, the control unit 130 may use a commonly known method in LiDAR. Moreover, the control unit 130 determines whether or not the laser light received by the light receiving unit 120 includes an optical communication code of another distance measuring device 100 (an optical communication code from another distance measuring device 100). If it is determined that the optical communication code of another distance measuring device 100 is included, the control unit 130 adjusts the wavelength of the laser light of its own distance measuring device 100 so that it does not overlap with the wavelength of the laser light of the other distance measuring device 100. Alternatively, one distance measuring device 100 may determine the wavelength assignment not only for its own distance measuring device 100 but also for other distance measuring devices 100.

The control unit 130 may determine the wavelength of the laser light output by its own distance measuring device 100, or the wavelength to be assigned to each distance measuring device 100, in consideration of the priority of each distance measuring device 100 and the usable wavelengths. For example, among the multiple distance measuring devices 100, a distance measuring device 100 having a lower priority may change the wavelength of the laser light it outputs.

The roles of the respective distance measuring devices 100 are not necessarily fixed and may be dynamically changeable depending on the situation. For example, the distance measuring device 100 that plays a leading role, such as a distance measuring device 100 that assigns wavelengths to each distance measuring device 100, may be determined based on factors such as battery level, required level of distance measurement accuracy, or installation position of the device.

Moreover, the distance measuring device 100 periodically transmits and receives optical communication codes even after the wavelength has been adjusted. This allows the distance measuring device 100 to detect the participation of a new distance measuring device 100 or the withdrawal of an existing distance measuring device 100, and to reallocate wavelengths as necessary. This enables the distance measuring device 100 to maintain stable distance measurement performance even in dynamically changing environments.

Thus, even in the case where multiple distance measuring devices 100 operate simultaneously within the same field of view, interference caused by laser light output at the same wavelength can be avoided. In this respect, each distance measuring device 100 can independently perform accurate distance measurements. Moreover, the distance measuring devices 100 can output optical communication codes while scanning with laser light, thereby enabling highly accurate measurements while ensuring real time performance.

FIG. 2 shows an example of the appearance of the distance measuring device 100. In the example of FIG. 2, a laser light emission port of the output unit 110 and a light receiving surface of the light receiving unit 120 are located on the same surface of the housing of the distance measuring device 100. The surface on which the laser light emission port of the output unit 110 and the light receiving surface of the light receiving unit 120 are located is also referred to as the front surface of the distance measuring device 100.

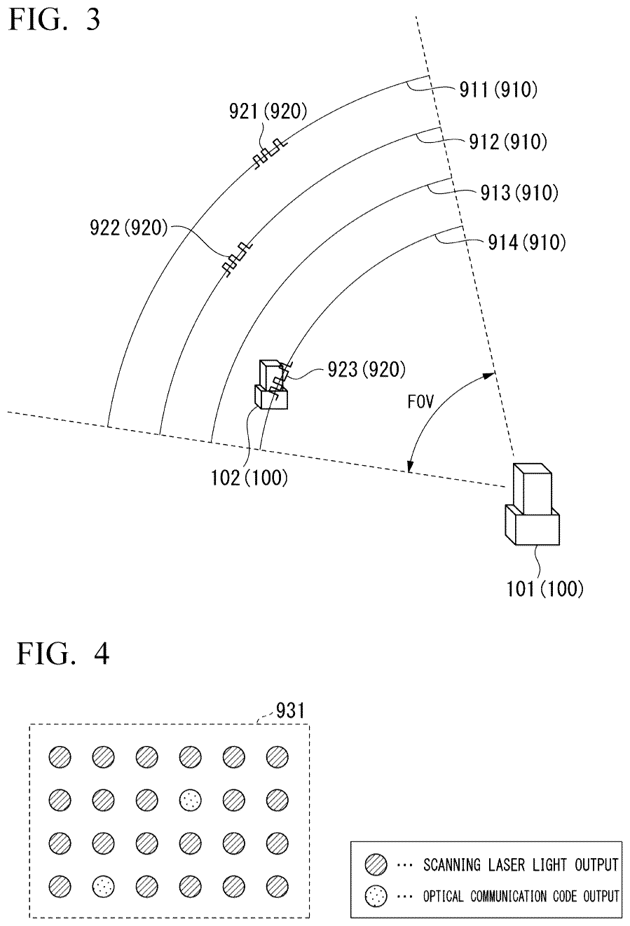

FIG. 3 shows a first example of laser light output by the distance measuring device 100. In the example of FIG. 3, two distance measuring devices 100 are shown, which are distinguished as distance measuring device 101 and distance measuring device 102. FIG. 3 shows an example of laser light output by the distance measuring device 101. Moreover, the distance measuring device 102 is located within the field of view of the distance measuring device 101. A part of the laser light output by the distance measuring device 101 can be received by the distance measuring device 102.

Each of lines 911 to 914 schematically indicates scanning performed by the distance measuring device 101. The distance measuring device 101 repeatedly scans within the field of view as shown by lines 911 to 914. Lines 911 to 914 are also collectively referred to as line 910. Each of symbols 921 to 923 schematically indicates the output of optical communication codes by the distance measuring device 101. Symbols 921 to 923 are also collectively referred to as symbol 920.

The fact that symbol 920 is shown overlapping the line 910 schematically indicates that the distance measuring device 101 outputs optical communication codes at a certain timing during scanning. In the example of FIG. 3, the distance measuring device 101 performs scanning by continuously changing the direction in which the laser light is output within the field of view while continuously outputting the laser light. The distance measuring device 101 outputs optical communication codes as a binary signal by switching the laser light output on and off at a certain timing during scanning.

This can be interpreted as the distance measuring device 101 outputting optical communication codes instead of laser light that is continuously emitted for scanning at a certain timing within the time period during which scanning is performed using laser light. After completing the output of the optical communication codes, the distance measuring device 101 again continuously emits laser light for scanning. The distance measuring device 101 may also measure distances using optical communication codes as laser light for scanning. Alternatively, the distance measuring device 101 may exclude the optical communication codes from the measurement target object.

The distance measuring device 101 outputs optical communication codes at a frequency that does not reduce the accuracy of distance measurement and that allows the optical communication codes to be output in various directions within the field of view through repeated scanning. The distance measuring device 101 may output optical communication codes multiple times during a single scan. The distance measuring device 101 may not output any optical communication codes during a single scan. The distance measuring device 101 may output optical communication codes at a random timing. Alternatively, the distance measuring device 101 may periodically output optical communication codes at time intervals such that the direction in which the optical communication codes are output differs for each scan. By repeatedly performing high-speed scanning, it is expected that the distance measuring device 102 receives the optical communication codes of the distance measuring device 101 within a comparatively short period of time, for example, within one second.

Here, consider the case where both of the distance measuring devices 101 and 102 can receive each other's laser light and both use laser light of the same wavelength. In such a case, either one of the distance measuring devices 101 or 102 may change the wavelength of the laser light it uses. For example, each of the distance measuring devices 101 and 102 may output optical communication codes including its own identification information, the wavelength of the laser light to be used, and its priority. Then, the one of the distance measuring devices 101 and 102 with lower priority may select, from among the wavelengths it can use, a wavelength other than that used by the other distance measuring device 100.

Alternatively, in the case where only one of the distance measuring devices 101 and 102 can change its wavelength, the device that can change the wavelength may change it. For example, each of the distance measuring devices 101 and 102 may output optical communication codes including its own identification information, the wavelength of the laser light it uses, and the wavelengths it can use. Each of the distance measuring devices 101 and 102 may determine, based on the optical communication codes of the other device, whether or not the other device can change its wavelength. Then, the one of the distance measuring devices 101 and 102 that determines that the other device cannot change its wavelength and that it itself can change its wavelength may change its wavelength.

Next, consider the case where the distance measuring device 102 receives the laser light of the distance measuring device 101, but the distance measuring device 101 does not receive the laser light of the distance measuring device 102. Such a case may occur depending on the relative positions and orientations of the distance measuring devices 101 and 102. In such a case, the distance measuring device 102 may change the wavelength of the laser light it uses. For example, each of the distance measuring devices 101 and 102 outputs optical communication codes including its own identification information, the wavelength of the laser light to be used, and its priority.

If the priority of the distance measuring device 102 is lower than that of the distance measuring device 101, the distance measuring device 102 changes its wavelength as described above. On the other hand, if the priority of the distance measuring device 102 is higher than that of the distance measuring device 101, the distance measuring device 102 determines, after outputting its own optical communication codes, whether or not the wavelength of the laser light used by the distance measuring device 101 has changed. If the wavelength of the laser light used by the distance measuring device 101 has not changed, it is considered that the distance measuring device 101 is not receiving the laser light of the distance measuring device 102. In such a case, the distance measuring device 102 changes the wavelength of the laser light it outputs. Alternatively, the distance measuring device 102 may output laser light indicating a reply request to the distance measuring device 101. The distance measuring device 102 may then determine, based on the presence or absence of a reply from the distance measuring device 101, whether or not the distance measuring device 101 is receiving the laser light of the distance measuring device 102.

FIG. 4 shows a second example of laser light output by the distance measuring device 100. FIG. 4 schematically shows scanning of a two-dimensional field of view by the distance measuring device 100. The region 931 shows an example of a two-dimensional field of view (for example, in vertical and horizontal directions) scanned by the distance measuring device 100. All of the circles shown in FIG. 4 can be regarded as an example of a point cloud in LiDAR. However, the number of positions subject to distance measurement by the distance measuring device 100 (the number of points included in the point cloud) is not limited to a particular number.

In the example of FIG. 4, the distance measuring device 100 outputs optical communication codes at some of the multiple positions of the measurement target object. As described above, the distance measuring device 100 may also measure distances by using optical communication codes as laser light for scanning. Alternatively, the distance measuring device 100 may exclude the optical communication codes from the measurement target object.

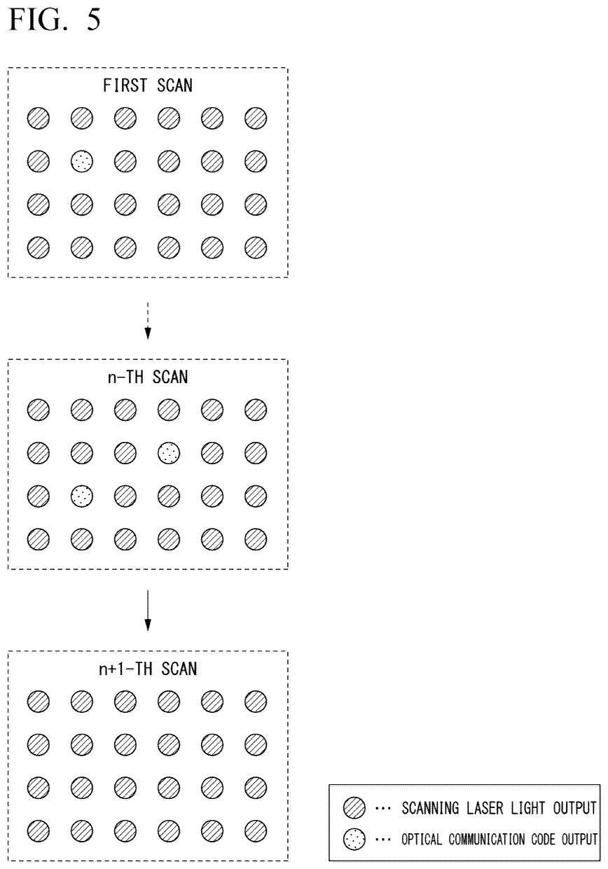

FIG. 5 shows a third example of laser light output by the distance measuring device 100. FIG. 5 schematically shows a time sequence of scanning of a two-dimensional field of view by the distance measuring device 100. As described above, the distance measuring device 100 outputs an optical communication code at a frequency that does not reduce the accuracy of distance measurement and that allows the optical communication code to be output in various directions within the field of view through repeated scanning. The distance measuring device 101 may output an optical communication code multiple times during a single scan. Alternatively the distance measuring device 101 may not output any optical communication code during a single scan.

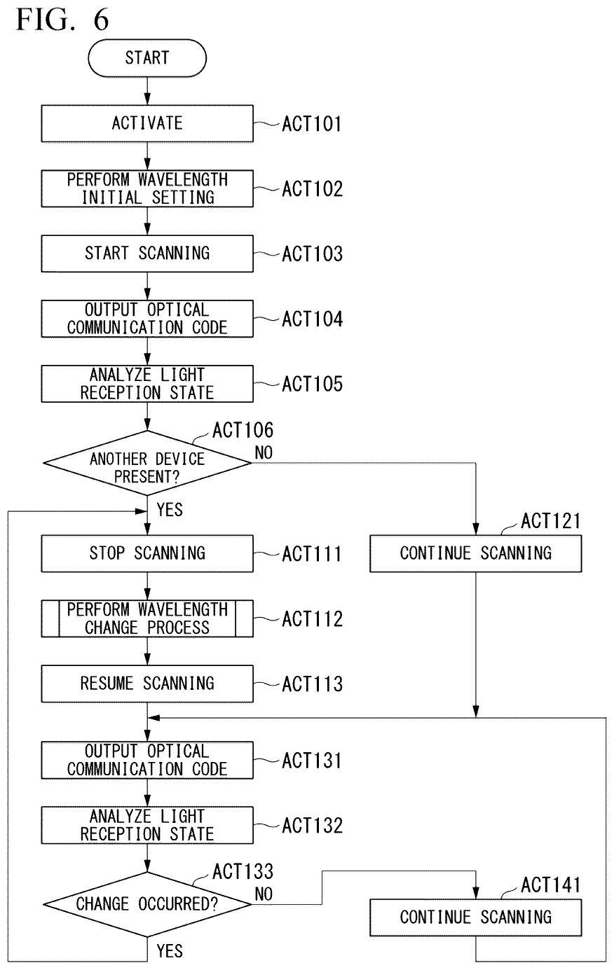

FIG. 6 shows an example of a procedure of processing performed by the distance measuring device 100. The distance measuring device 100 starts the processing of FIG. 6 when, for example, its power supply is connected (turned on). Then, the distance measuring device 100 performs the processing of FIG. 6 until, for example, a user operation to terminate distance measurement is received and the distance measurement is completed.

### ACT101

The distance measuring device 100 is activated.

Upon completion of the activation in ACT101, the processing transitions to ACT102.

### ACT102

The control unit 130 performs an initial setting of the wavelength of the laser light to be used. For example, the control unit 130 sets the wavelength of the laser light to be used to a preliminarily stored wavelength.

After ACT102, the processing transitions to ACT103.

### ACT103

The output unit 110, under the control of the control unit 130, starts scanning using the laser light with the wavelength set in ACT102.

In the scanning process, the output unit 110 outputs the laser light while changing the direction of the laser light within the range of the field of view. The light receiving unit 120 receives the reflected light of the laser light output from the output unit 110. Based on the light reception state of the light receiving unit 120, the control unit 130 calculates the distance from its own distance measuring device 100 to the measurement target object (object reflecting the laser light). The light receiving unit 120 and the control unit 130 repeatedly perform light reception and distance calculation according to the scanning performed by the output unit 110.

After ACT103, the processing transitions to ACT104.

### ACT104

At a certain timing after the start of scanning in ACT103, the output unit 110 outputs an optical communication code under the control of the control unit 130. As described above, the output unit 110 outputs the optical communication code during scanning. For example, as described above, the output unit 110 may output the optical communication code at a random timing during scanning.

After ACT104, the processing transitions to ACT105.

### ACT105

The control unit 130 analyzes the light reception state of the light receiving unit 120 in order to detect another distance measuring device 100. Specifically, the control unit 130 attempts to extract identification information of another distance measuring device 100 from the laser light received by the light receiving unit 120. As described above, the identification information of another distance measuring device 100 is included in the optical communication code of the another distance measuring device 100.

The another distance measuring device 100 is also referred to as “another device”. The distance measuring device 100 of its own is also referred to as “own device”. The distance measuring device 100 itself is also referred to as “own device”.

FIG. 6 shows an example in which the control unit 130 performs the analysis in ACT105 after the output unit 110 has output the optical communication code once in ACT104. However, the timing at which the control unit 130 performs the analysis in ACT105 is not limited to any particular timing. For example, the control unit 130 may perform the analysis in ACT105 at a random timing different from the timing at which the output unit 110 outputs the optical communication code in ACT104.

In particular, the number of times the output unit 110 outputs the optical communication code in ACT104 before the control unit 130 performs the analysis in ACT105 is not limited to any particular number. The output unit 110 may output the optical communication code in ACT104 multiple times before the control unit 130 performs the analysis in ACT105. Moreover, the output unit 110 may not output the optical communication code in ACT104.

In order to enable the execution of the process in ACT105 without the need for prior synchronization between distance measuring devices 100, the control unit 130 may store, as time-series data of binary signals, the laser light received by the light receiving unit 120 during a recent predetermined period of time. The control unit 130 may then attempt to extract the identification information of another device from the stored time-series data of binary signals.

Moreover, in the case where the laser light emitted from the output unit 110 may interfere with the analysis performed in ACT105, the control unit 130 may cause the output unit 110 to temporarily stop outputting laser light for a predetermined period of time immediately before performing the analysis in ACT105. After ACT105, the processing transitions to ACT106.

### ACT106

The control unit 130 determines whether or not there is another device that can receive laser light from the own device, based on the analysis results of ACT105. If one or more pieces of identification information of another device are extracted in ACT105, the control unit 130 determines that another device exists. On the other hand, if no identification information of another device is extracted in ACT105, the control unit 130 determines that there is no other device.

If the control unit 130 determines that another device exists (ACT106: YES), the processing transitions to ACT111.

On the other hand, if the control unit 130 determines that there is no other device (ACT106: NO), the processing transitions to ACT121.

In ACT105, the control unit 130 may further determine whether it is necessary to change the wavelength of the laser light. For example, if the control unit 130 determines that there is another device that can receive laser light from the own device, the control unit 130 may further determine whether there is any other device among those that can receive laser light from the own device that uses the same wavelength of laser light as the own device. If it is determined that there is another device using the same wavelength of laser light as the own device, the control unit 130 may further determine whether or not there is any other device among them that has a higher priority than the own device.

If the control unit 130 determines that there is another device that can receive laser light from the own device, that uses the same wavelength of laser light as the own device, and has a higher priority than the own device, the processing transitions to ACT111. If the control unit 130 determines that there is no other device that can receive laser light from the own device, that uses the same wavelength of laser light as the own device, and has a higher priority than the own device, the processing transitions to ACT121.

### ACT111

The output unit 110 stops scanning according to the control of the control unit 130. This allows preparation for changing the wavelength of the output laser light.

After ACT111, the processing transitions to ACT112.

### ACT112

The control unit 130 determines whether or not it is necessary to change the wavelength of the laser light output by the own device, and if it determines that a wavelength change is necessary, changes the wavelength. The process of determining whether or not it is necessary to change the wavelength of the laser light output by the own device, and changing the wavelength if it is determined to be necessary, is also referred to as a wavelength change process.

If it has already been determined in ACT106 that a wavelength change is necessary, the control unit 130 performs the wavelength change in ACT112.

After ACT112, the processing transitions to ACT113.

### ACT113

The output unit 110 resumes scanning according to the control of the control unit 130. If the control unit 130 has changed the wavelength in ACT112, the output unit 110 resumes scanning with the laser light of the changed wavelength.

After ACT113, the processing transitions to ACT131.

### ACT121

The output unit 110 continues to perform scanning according to the control of the control unit 130.

After ACT121, the processing transitions to ACT131.

### ACT131

The process in ACT131 is the same as the process in ACT104. If the processing transitions from ACT113 to ACT131, the output unit 110, at a certain timing after the scanning resumes in ACT113, outputs an optical communication code at the wavelength changed in ACT112 according to the control of the control unit 130. If the processing transitions from ACT121 to ACT131, the output unit 110, at a certain timing during the scanning performed by continuing scanning in ACT121, outputs an optical communication code according to the control of the control unit 130. If the processing transitions from ACT141 to ACT131, the output unit 110, at a certain timing during the scanning performed by continuing scanning in ACT141, outputs an optical communication code according to the control of the control unit 130.

In any of the cases where the processing transitions from ACT113 to ACT131, from ACT121 to ACT131, or from ACT141 to ACT131, as described above, the output unit 110 outputs an optical communication code during scanning. For example, as described above, the output unit 110 may output the optical communication code at a random timing during scanning. After ACT131, the processing transitions to ACT132.

### ACT132

The process in ACT132 is the same as the process in ACT105. The control unit 130 analyzes the light reception state of the light receiving unit 120 in order to detect another device.

FIG. 6 shows an example in which the control unit 130 performs the analysis in ACT132 after the output unit 110 has output the optical communication code once in ACT131. However, the timing at which the control unit 130 performs the analysis in ACT132 is not limited to any particular timing. For example, the control unit 130 may perform the analysis in ACT132 at a random timing different from the timing at which the output unit 110 outputs the optical communication code in ACT131.

In particular, the number of times the output unit 110 outputs the optical communication code in ACT131 before the control unit 130 performs the analysis in ACT132 is not limited to any particular number. The output unit 110 may output the optical communication code in ACT131 multiple times before the control unit 130 performs the analysis in ACT132. Alternatively, the output unit 110 may not output the optical communication code in ACT131.

Moreover, the output unit 110 repeatedly performs the process in ACT131 through the loops of processes from ACT111 to ACT133 and from ACT131 to ACT141. In doing so, the output unit 110 may vary the number of times it outputs the optical communication code each time it executes the process in ACT131.

Moreover, in the case where the laser light emitted from the output unit 110 may interfere with the analysis performed in ACT132, the control unit 130 may cause the output unit 110 to temporarily stop outputting laser light for a predetermined period of time immediately before performing the analysis in ACT132.

After ACT132, the processing transitions to ACT133.

### ACT133

The control unit 130 determines whether or not there has been any change in other devices that can receive laser light from the own device, based on the analysis results from ACT132. Specifically, the control unit 130 compares the identification information of other devices detected in the most recent analysis using the identification information of other devices detected in the previous analysis. Through this, the control unit 130 determines whether or not any new other device has been added as a device that can receive laser light from the own device, and whether or not any other device has been removed from other devices that can receive laser light from the own device.

Here, a change in other devices that can receive laser light from the own device means that there is at least one of a new other device has been added as a device that can receive laser light from the own device or another device has been removed from the other devices that can receive laser light from the own device.

If the control unit 130 determines that there has been a change in other devices (ACT133: YES), the processing transitions to ACT111.

On the other hand, if the control unit 130 determines that there is no change in other devices (ACT133: NO), the processing transitions to ACT141.

### ACT141

The process in ACT141 is the same as the process in ACT121. In ACT141, the output unit 110 continues to perform scanning according to the control of the control unit 130.

After ACT141, the processing transitions to ACT131.

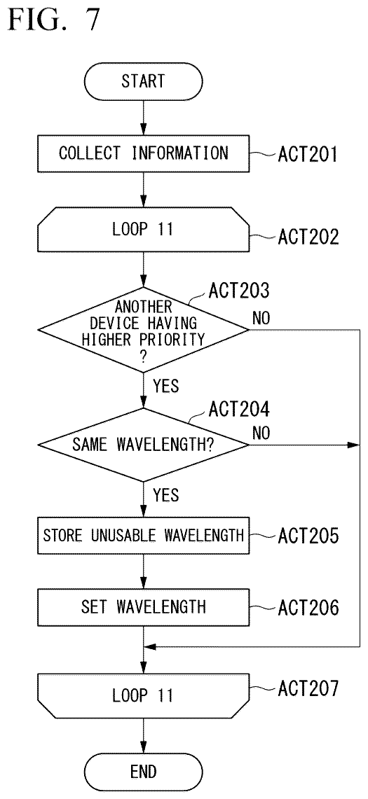

FIG. 7 shows an example of a procedure in which the distance measuring device 100 performs the wavelength change process. The distance measuring device 100 performs the process of FIG. 7 in ACT112 of FIG. 6.

### ACT201

The distance measuring device 100 collects information on each other device from which identification information was detected in the most recent analysis in ACT105 or ACT132 of FIG. 6. For example, in ACT104 and ACT131, the distance measuring device 100 may output an optical communication code including only its own identification information. In particular, in ACT104 and ACT131, the distance measuring device 100 may output an optical communication code that does not include information indicating the wavelength of the laser light output by the own device and information indicating the priority of the own device. Then, in ACT201, the distance measuring device 100 may acquire, for each of the other devices from which the own device can receive laser light, information indicating the wavelength of the laser light output by the other devices and information indicating the priority of the other devices.

In order to enable the process in ACT201 to be executed without prior synchronization between distance measuring devices 100, the distance measuring device 100 may output laser light indicating a request for information in ACT201. Then, the distance measuring device 100 that receives the laser light indicating the request for information may immediately output the requested information using laser light.

In ACT201, the distance measuring device 100 may further acquire information on whether or not each other device is receiving the laser light of the own device. For example, as described above, the distance measuring device 100 may output laser light indicating a reply request to the other devices. The distance measuring device 100 may then determine, based on the presence or absence of a reply from the other devices, whether or not another devices is receiving the laser light of the own device. The fact that both of the two distance measuring devices 100 are receiving each other's laser light may also be referred to as the two distance measuring devices 100 being able to exchange information. The distance measuring device 100 may exclude, from the wavelengths usable by the own device, the wavelengths used by other devices that are determined as not receiving the laser light of the own device. The laser light indicating a request for information may also serve as laser light that requests a reply.

In ACT104 and ACT131 of FIG. 6, in the case where the distance measuring device 100 outputs an optical communication code including, in addition to its own identification information, information indicating the wavelength of the laser light it outputs and information indicating its priority, the distance measuring device 100 may perform no action in ACT201. In such a case, ACT201 may be omitted. After ACT201, the processing transitions to ACT202.

### ACT202

The control unit 130 starts Loop 11, which performs a process for each other device whose identification information was detected in the most recent analysis in ACT105 or ACT132 of FIG. 6. The other device that is the subject of the process in Loop 11 is also referred to as the other process target device.

If, in ACT201, the distance measuring device 100 has acquired information on whether or not each other device is receiving the laser light from the own device, the control unit 130 may set as the target of Loop 11 only those other devices that are receiving the laser light from the own device.

After ACT202, the processing transitions to ACT203.

### ACT203

The control unit 130 determines whether or not the other process target device has a higher priority than the own device.

If the control unit 130 determines that the other process target device has a higher priority than the own device (ACT203: YES), the processing transitions to ACT204.

On the other hand, if the control unit 130 determines that the other process target device does not have a higher priority than the own device (ACT203: NO), the processing transitions to ACT207.

### ACT204

The control unit 130 determines whether or not the wavelength of the laser light output by the other process target device is the same as the wavelength of the laser light output by the own device.

If the control unit 130 determines that the wavelengths are the same (ACT204: YES), the processing transitions to ACT205.

On the other hand, if the control unit 130 determines that the wavelengths are different (ACT204: NO), the processing transitions to ACT207.

### ACT205

The control unit 130 stores the current wavelength of the laser light output by the own device (that is, the wavelength determined to be the same as the laser light output by the other process target device) as an unusable wavelength. At the start of the processing in FIG. 7, the control unit 130 deletes all wavelengths stored as unusable wavelengths. In other words, the control unit 130 resets the information on unusable wavelengths.

After ACT205, the processing transitions to ACT206.

### ACT206

The control unit 130 sets one of the wavelengths that the own device can output as laser light, and that is usable (that is, a wavelength other than those stored as unusable wavelengths), as the wavelength for the own device to output laser light.

After ACT206, the processing transitions to ACT207.

### ACT207

The control unit 130 performs the termination process of Loop 11. Specifically, the control unit 130 determines whether or not the process of Loop 11 has been performed for all other devices whose identification information was detected in the most recent analysis in ACT105 or ACT132.

If it is determined that there are other devices for which the process of Loop 11 has not yet been performed, the control unit 130 continues to perform the process of Loop 11 for those other devices.

On the other hand, if it is determined that Loop 11 has been performed for all other devices, the control unit 130 ends Loop 11. When the control unit 130 ends Loop 11, the distance measuring device 100 completes the processing in FIG. 7. As a result, the processing transitions to ACT113 of FIG. 6.

A single distance measuring device 100 may assign laser light wavelengths to the own device and to all other devices that can exchange information with it. A distance measuring device 100 that assigns laser light wavelengths to the own device and all other devices that can exchange information with it is also referred to as a wavelength determination distance measuring device.

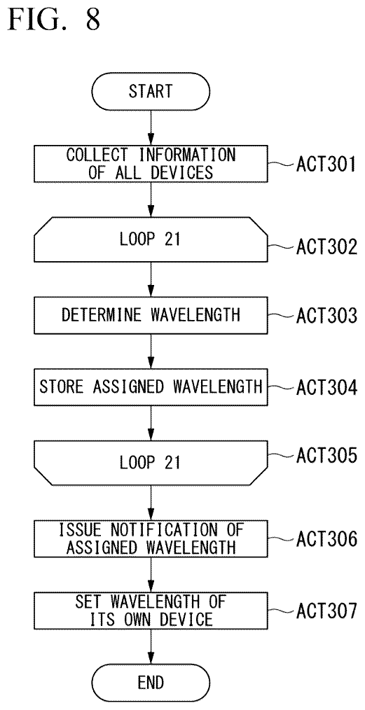

FIG. 8 shows an example of the procedure in which a distance measuring device 100 assigns laser light wavelengths to itself and to all other devices with which the own device can exchange information. The wavelength determination distance measuring device performs the procedure of FIG. 8 instead of the procedure of FIG. 7, in ACT112 of FIG. 6.

### ACT301

The wavelength determination distance measuring device collects information on all other devices with which the own device can exchange information. For example, in ACT104 and ACT131, the distance measuring device 100 may output an optical communication code including only its own identification information. In particular, in ACT104 and ACT131, the distance measuring device 100 may output an optical communication code that does not include information indicating the wavelength of the laser light that can be output by the own device and information indicating the priority of the own device. Then, in ACT301, the wavelength determination distance measuring device may acquire, for all other devices with which the own device can exchange information, information indicating the laser wavelength each other device can output and information indicating the priority of each other device.

In order to enable the process in ACT301 to be executed without prior synchronization between distance measuring devices 100, the wavelength determination distance measuring device may output laser light indicating a request for information in ACT301. Then, all other devices that receive the laser light indicating the request for information may immediately output the requested information using laser light.

In ACT201, the wavelength determination distance measuring device may further acquire information on whether or not each other device is receiving the laser light of the own device. For example, as described above, the wavelength determination distance measuring device may output laser light indicating a reply request to the other devices. The wavelength determination distance measuring device may then determine, based on the presence or absence of a reply from the other devices, whether or not another device is receiving the laser light of the own device. The wavelength determination distance measuring device may exclude, from the wavelengths to be assigned, the wavelengths used by other devices that are determined as not receiving the laser light of the own device. The laser light indicating a request for information may also serve as laser light that requests a reply. Alternatively, in the case where multiple distance measuring devices 100 are always arranged to be able to exchange information, the wavelength determination distance measuring device may perform the processing assuming that it can exchange information with all other devices.

In ACT104 and ACT131 of FIG. 6, in the case where the distance measuring device 100 outputs an optical communication code including, in addition to its own identification information, information indicating the wavelength of the laser light it outputs and information indicating its priority, the wavelength determination distance measuring device may perform no action in ACT301. In such a case, ACT301 may be omitted. After ACT301, the processing transitions to ACT302.

### ACT302

The control unit 130 starts Loop 21 to perform processing for the own device and each other device that can exchange information with the own device. The distance measuring device 100 that is the subject of the process in Loop 21 is also referred to as the process target distance measuring device 100. The control unit 130 may treat the own device and other devices that can exchange information in order of descending priority, treating each as the process target distance measuring device 100.

After ACT302, the processing transitions to ACT303.

### ACT303

The control unit 130 determines the wavelength to be assigned to the process target distance measuring device 100. Specifically, the control unit 130 selects, as the wavelength to assign to the process target distance measuring device 100, one wavelength that the device can output and that has not yet been assigned to any other distance measuring device 100.

After ACT303, the processing transitions to ACT304.

### ACT304

The control unit 130 stores the wavelength assigned to the process target distance measuring device 100 in ACT303 as an assigned wavelength.

After ACT304, the processing transitions to ACT305.

### ACT305

The control unit 130 performs the termination process of Loop 21. Specifically, the control unit 130 determines whether or not the process of Loop 21 has been performed for the own device and all other devices that can exchange information with the own device.

If it is determined that there is a distance measuring device 100 for which the process of Loop 21 has not yet been performed, the control unit 130 continues to perform the process of Loop 21 for the distance measuring device 100.

On the other hand, if it is determined that the process of Loop 21 has been performed for the own device and all other devices that can exchange information with the own device, the control unit 130 terminates loop 21.

When the control unit 130 terminates Loop 21, the processing transitions to ACT306.

### ACT306

The wavelength determination distance measuring device notifies each other device that can exchange information with the own device of the wavelength assigned to that other device. For example, the output unit 110, according to the control of the control unit 130, outputs for each other device the identification information of the own device and the wavelength assigned to that other device by means of laser light.

After ACT306, the processing transitions to ACT307.

### ACT307

The control unit 130 sets the wavelength of the laser light output by the own device. In other words, the control unit 130 adjusts the laser light output mechanism of the output unit 110 so that the wavelength of the laser light output by the output unit 110 matches the wavelength assigned to the own device.

After ACT307, the wavelength determination distance measuring device ends the processing of FIG. 8. As a result, the processing transitions to ACT113 of FIG. 6.

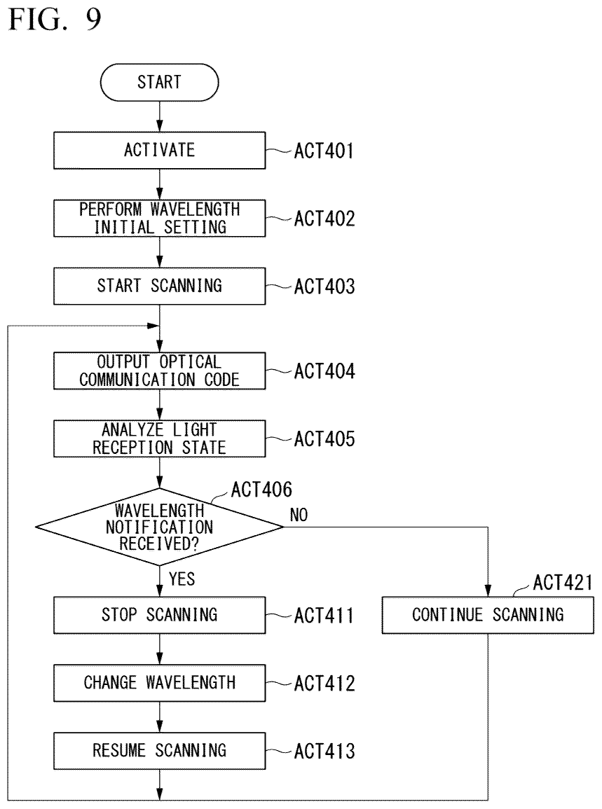

FIG. 9 shows an example of a procedure performed by another device that receives a wavelength assignment from a wavelength determination distance measuring device. The other device that receives the wavelength assignment from the wavelength determination distance measuring device performs the processing of FIG. 9 instead of the processing of FIG. 6. In the description of FIG. 9, the other device that receives the wavelength assignment from the wavelength determination distance measuring device is also simply referred to as distance measuring device 100. The distance measuring device 100 starts the processing of FIG. 9 when, for example, its power supply is connected (turned on). Then, the distance measuring device 100 performs the processing of FIG. 9 until, for example, a user operation to terminate distance measurement is received and the distance measurement is completed.

The processes in ACT401 to ACT403 are the same as the processes in ACT101 to ACT103 in FIG. 6. After ACT403, the processing transitions to ACT404.

### ACT404

The process in ACT404 is the same as the process in ACT104 in FIG. 6. If the processing transitions from ACT403 to ACT404, the output unit 110, at a certain timing after the start of scanning in ACT403, outputs an optical communication code according to the control of the control unit 130. Moreover, if the processing transitions from ACT413 to ACT404, the output unit 110, at a certain timing after the scanning resumes in ACT413, outputs an optical communication code at the wavelength changed in ACT412 according to the control of the control unit 130. If the processing transitions from ACT421 to ACT404, the output unit 110, at a certain timing during the scanning performed by continuing scanning in ACT421, outputs an optical communication code according to the control of the control unit 130.

In any of the cases where the processing transitions from ACT403 to ACT404, from ACT413 to ACT404, or from ACT421 to ACT404, as described above, the output unit 110 outputs an optical communication code during scanning. For example, as described above, the output unit 110 may output the optical communication code at a random timing during scanning.

After ACT404, the processing transitions to ACT405.

### ACT405

The control unit 130 analyzes the light reception state of the light receiving unit 120 in order to detect a notification from the wavelength determination distance measuring device regarding the wavelength assigned to the own device. For example, the control unit 130 attempts to extract information from the laser light received by the light receiving unit 120 in which the identification information of the own device is associated with the wavelength.

FIG. 9 shows an example in which the control unit 130 performs the analysis in ACT405 after the output unit 110 has output the optical communication code once in ACT404. However, the timing at which the control unit 130 performs the analysis in ACT405 can be any timing after the output unit 110 has output the optical communication code one or more times. For example, the control unit 130 may perform the analysis in ACT405 at a random timing after the output unit 110 has output the optical communication code one or more times in ACT404.

In particular, the number of times the output unit 110 outputs the optical communication code in ACT404 before the control unit 130 performs the analysis in ACT405 may be one or more times, and is not limited to any particular number. The output unit 110 may output the optical communication code in ACT404 multiple times before the control unit 130 performs the analysis in ACT405.

In order to enable the execution of the process in ACT105 without the need for prior synchronization between distance measuring devices 100, the control unit 130 may store, as time-series data of binary signals, the laser light received by the light receiving unit 120 during a recent predetermined period of time. Then, the control unit 130 may attempt to notify the wavelength assigned to the own device, from the stored time-series data of the binary signals.

Moreover, in the case where the laser light emitted from the output unit 110 may interfere with the analysis performed in ACT405, the control unit 130 may cause the output unit 110 to temporarily stop outputting laser light for a predetermined period of time immediately before performing the analysis in ACT405.

After ACT405, the processing transitions to ACT406.

### ACT406

The control unit 130 determines, based on the analysis results in ACT405, whether or not the notification of the wavelength assigned to the own device has been received.

If the control unit 130 determines that the notification of the wavelength assigned to the own device has been received (ACT406: YES), the processing transitions to ACT411.

On the other hand, if the control unit 130 determines that the notification of the wavelength assigned to the own device has not been received (ACT406: NO), the processing transitions to ACT421.

### ACT411

The output unit 110 stops scanning according to the control of the control unit 130. This allows preparation for changing the wavelength of the output laser light.

After ACT411, the processing transitions to ACT412.

### ACT412

The control unit 130 sets the wavelength of the laser light output by the own device. In other words, the control unit 130 adjusts the laser light output mechanism of the output unit 110 so that the wavelength of the laser light output by the output unit 110 matches the wavelength assigned to the own device.

After ACT412, the processing transitions to ACT413.

### ACT413

The output unit 110 resumes scanning according to the control of the control unit 130. The output unit 110 resumes scanning with the laser light of the wavelength set in ACT412.

After ACT413, the processing transitions to ACT404.

### ACT421

The output unit 110 continues to perform scanning according to the control of the control unit 130.

After ACT421, the processing transitions to ACT404.

As described above, the output unit 110 outputs laser light with a variable wavelength. The light receiving unit 120 receives the laser light. The control unit 130 causes the output unit 110 to output identification information of the own device by means of laser light, and determines a wavelength of the laser light to be output from the output unit 110, based on the light reception state of the identification information for each distance measuring device 100 by the light receiving unit 120. According to the distance measuring device 100, it is possible to detect other devices with overlapping fields of view, and to determine the wavelength of the laser light of the own device, so that it outputs laser light with a wavelength different from those other devices. In this respect, it is possible to enable prevention of erroneous distance measurements or distance measurement errors caused by interference of laser lights from multiple distance measuring devices 100 in the case where the multiple distance measuring devices 100 perform distance measurement simultaneously in the state where their fields of view overlap.

Moreover, the control unit 130 causes the output unit 110 to output the identification information of the own device by means of the laser light within a time period during which scanning with the laser light is performed. According to the distance measuring device 100, it is possible to insert an optical communication code between laser scans for distance measurement. According to the distance measuring device 100, in this respect, information for adjusting the wavelength of the laser light can be transmitted without interrupting distance measurement.

Moreover, the control unit 130 causes the output unit 110 to output, in addition to the identification information of the own device, information indicating the wavelength used by the own device by means of the laser light, and determines the wavelength of the laser light to be output from the output unit 110 based on the reception state of the identification information and the information indicating the wavelength used by each distance measuring device 100 received by the light receiving unit 120. According to the distance measuring device 100, it is possible to acquire information indicating the wavelength of the laser light output by another device without the need for analyzing the laser light received by the light receiving unit 120. According to the distance measuring device 100, it is possible to use this information to adjust the wavelength of the laser light that the own device outputs.

Moreover, the control unit 130 causes the output unit 110 to output information indicating a usable wavelength of the own device by means of the laser light, in addition to the identification information of the own device, assigns a wavelength to each distance measuring device 100 based on the reception state of the identification information and the information indicating the wavelength usable by each distance measuring device 100 received by the light receiving unit 120, and causes the output unit 110 to output, by means of the laser light, information indicating the assigned wavelength from the output unit 110 to the corresponding distance measuring device 100. According to the distance measuring device 100, it is possible to acquire information indicating the wavelength of the laser light that can be output by the other device without the need for storing the wavelength of the laser light that can be output by the other device in advance. According to the distance measuring device 100, it is possible to use this information to determine the wavelengths to be assigned to each distance measuring device 100.

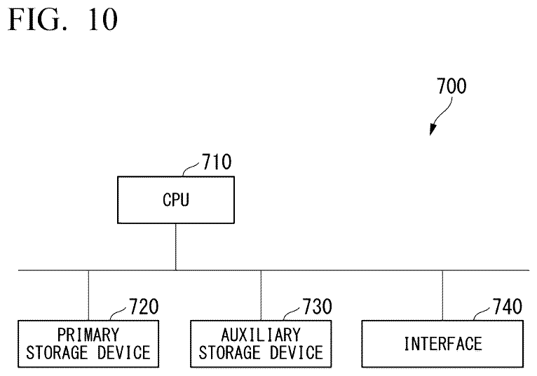

FIG. 10 shows a configuration example of a computer according to the embodiment. In the configuration shown in FIG. 10, a computer 700 includes a CPU 710, a primary storage device 720, an auxiliary storage device 730, and an interface 740.

The above control unit 130 or part thereof may be implemented in the computer 700. In such a case, the operations of the control unit 130 are stored in the auxiliary storage device 730 in the form of a program. The CPU 710 reads out the program from the auxiliary storage device 730, loads it into the primary storage device 720, and executes the processes described above, according to the program.

Also, the CPU 710 secures a memory storage region in the primary storage device 720 for executing the functions of the control unit 130 according to the program. The laser light output by the output unit 110 is realized by the interface 740 outputting a control signal to the output unit 110, causing it to output laser light. Processing for the light reception performed by the light receiving unit 120 is executed by the interface 740 receiving a signal indicating light reception from the light receiving unit 120, and the CPU 710 performing processing based on that signal.

It should be noted that a program for executing some or all of the processes performed by the control unit 130 may be recorded on a computer-readable recording medium, and the program recorded on the recording medium may be read into and executed on a computer system, to thereby perform the processing of the control unit 130. The “computer system” here includes an OS (operating system) and hardware such as peripheral devices. Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built into a computer system. The above program may be a program for realizing a part of the functions described above, or may be a program capable of realizing the functions described above in combination with a program already recorded in a computer system.

The embodiments of this disclosure have been described in detail with reference to the drawings. However, the specific configuration of this disclosure is not limited to the embodiments, and may include designs and so forth that do not depart from the scope of the present invention.

What is claimed is:

1. A distance measuring device comprising:
an output unit that outputs laser light with a variable wavelength;
a light receiving unit that receives laser light; and
a control unit that causes the output unit to output identification information of the distance measuring device by laser light, and determines a wavelength of laser light to be output from the output unit based on a light reception state of identification information for each distance measuring device by the light receiving unit.

2. The distance measuring device according to claim 1, wherein the control unit causes the output unit to output the identification information of the distance measuring device by the laser light within a time period during which scanning with the laser light is performed.

3. The distance measuring device according to claim 1, wherein the control unit causes the output unit to output, in addition to the identification information of the distance measuring device, information indicating a wavelength used by the distance measuring device by the laser light, and determines the wavelength of the laser light to be output from the output unit based on a reception state of the identification information and information indicating a wavelength used by each distance measuring device received by the light receiving unit.

4. The distance measuring device according to claim 1, wherein the control unit causes the output unit to output, in addition to the identification information of the distance measuring device, information indicating a usable wavelength of the distance measuring device by the laser light, assigns a wavelength to each distance measuring device based on a reception state of the identification information and information indicating a usable wavelength of each distance measuring device received by the light receiving unit, and causes the output unit to output, by the laser light, information indicating the assigned wavelength from the output unit to the corresponding distance measuring device.

5. The distance measuring device according to claim 1, wherein the control unit causes the output unit to output, in addition to the identification information of the distance measuring device, information indicating a priority of the distance measuring device by the laser light.

6. The distance measuring device according to claim 1, wherein, in a case where a priority of the distance measuring device is lower than another device, the control unit changes the wavelength of the laser light to be output from the output unit to a wavelength different from a wavelength used by the other device.

7. The distance measuring device according to claim 1, wherein, in a case where a priority of the distance measuring device is higher than another device, the control unit determines whether a wavelength of laser light used by the other device is changed.

8. The distance measuring device according to claim 1, wherein the output unit outputs an optical communication code including the identification information of the distance measuring device by using a binary signal generated by switching an output of the laser light between on and off.

9. A distance measuring method executed by a computer that controls a distance measuring device including an output unit that outputs laser light with a variable wavelength and a light receiving unit that receives laser light, the method comprising:
causing the output unit to output identification information of the distance measuring device by laser light, and
determining a wavelength of laser light to be output from the output unit based on a light reception state of identification information for each distance measuring device by the light receiving unit.

10. The distance measuring method according to claim 9,
wherein causing the output unit to output the identification information of the distance measuring device by the laser light comprises:
causing the output unit to output the identification information of the distance measuring device by the laser light within a time period during which scanning with the laser light is performed.

11. The distance measuring method according to claim 9,
wherein causing the output unit to output the identification information of the distance measuring device by the laser light comprises:
causing the output unit to output, in addition to the identification information of the distance measuring device, information indicating a wavelength used by the distance measuring device by the laser light, and
wherein the distance measuring method further comprises:
determining the wavelength of the laser light to be output from the output unit based on a reception state of the identification information and information indicating a wavelength used by each distance measuring device received by the light receiving unit.

12. The distance measuring method according to claim 9,
wherein causing the output unit to output the identification information of the distance measuring device by the laser light comprises:
causing the output unit to output, in addition to the identification information of the distance measuring device, information indicating a usable wavelength of the distance measuring device by the laser light, and
wherein the distance measuring method further comprises:
assigning a wavelength to each distance measuring device based on a reception state of the identification information and information indicating a usable wavelength of each distance measuring device received by the light receiving unit; and
causing the output unit to output, by the laser light, information indicating the assigned wavelength to the corresponding distance measuring device.

13. The distance measuring method according to claim 9,
wherein causing the output unit to output the identification information of the distance measuring device by the laser light comprises:
causing the output unit to output, in addition to the identification information of the distance measuring device, information indicating a priority of the distance measuring device by the laser light.

14. The distance measuring method according to claim 9, further comprising:
in a case where a priority of the distance measuring device is lower than another device, changing the wavelength of the laser light to be output from the output unit to a wavelength different from a wavelength used by the other device.

15. The distance measuring method according to claim 9, further comprising:
in a case where a priority of the distance measuring device is higher than another device, determining whether a wavelength of laser light used by the other device is changed.

16. The distance measuring method according to claim 9, further comprising:
outputting an optical communication code including the identification information of the distance measuring device by using a binary signal generated by switching an output of the laser light between on and off.

17. A non-transitory recording medium that stores a program causing a computer that controls a distance measuring device including an output unit that outputs laser light with a variable wavelength and a light receiving unit that receives laser light, to execute:
causing the output unit to output identification information of the distance measuring device by the laser light; and
determining a wavelength of laser light to be output from the output unit based on a light reception state of identification information for each distance measuring device by the light receiving unit.

18. The non-transitory recording medium according to claim 17,
wherein causing the output unit to output the identification information of the distance measuring device by the laser light comprises:
causing the output unit to output the identification information of the distance measuring device by the laser light within a time period during which scanning with the laser light is performed.

19. The non-transitory recording medium according to claim 17,
wherein causing the output unit to output the identification information of the distance measuring device by the laser light comprises:
causing the output unit to output, in addition to the identification information of the distance measuring device, information indicating a wavelength used by the distance measuring device by the laser light, and
wherein the program further comprises the computer to execute:
determining the wavelength of the laser light to be output from the output unit based on a reception state of the identification information and information indicating a wavelength used by each distance measuring device received by the light receiving unit.

20. The non-transitory recording medium according to claim 17,
wherein causing the output unit to output the identification information of the distance measuring device by the laser light comprises:
causing the output unit to output, in addition to the identification information of the distance measuring device, information indicating a usable wavelength of the distance measuring device by the laser light, and
wherein the program further comprises the computer to execute:
assigning a wavelength to each distance measuring device based on a reception state of the identification information and information indicating a usable wavelength of each distance measuring device received by the light receiving unit; and
causing the output unit to output, by the laser light, information indicating the assigned wavelength to the corresponding distance measuring device.
